(19) United States
(12) Patent Application Publication
(10) Pub. No.: US 2006/0053675 A1
(43) Pub. Date: Mar. 16, 2006

(54) Decoy and support therefor

(76) Inventor: Glenn Lindaman, Whitehall, PA (US)

Correspondence Address: DUANE MORRIS, LLP;IP DEPARTMENT, 30 SOUTH 17TH STREET, PHILADELPHIA, PA, 19103-4196, US

(21) Appl. No.: 11/204,902

(22) Filed: Aug. 15, 2005

Related U.S. Application Data
(60) Provisional application No. 60/609,144, filed on Sep. 10, 2004.

(51) Int. Cl. A01M 31/06

(52) U.S. Cl. 43/2

(57) ABSTRACT

A hunting decoy for fowl such as wild turkey or goose has a support shaft that can include a ground piercing stake, and two diverging support shafts that independently support a hollow decoy body and a decoy head assembly, normally including a head and neck. The two diverging support shafts permit independent movement of the body and the head assembly relative to the support shaft and relative to one another. The support shaft for the body can be vertically oriented and connects to the dorsal or back part of the decoy body at a fitting. The fitting can have a spring such as a helical spring that permits flexing and also can resiliently clamp against the decoy body to damp the extent of rotation. A similar fitting for the head assembly permits a head bobbing or pecking motion.

### CROSS REFERENCE TO RELATED APPLICATION

This application claims the priority of U.S. provisional patent application Ser. No. 60/609,144, filed Sep. 10, 2004.

### BACKGROUND OF THE INVENTION

1. Field of the Invention

The invention of this application concerns improved bird hunting decoys and supports for deployed decoys, and more particularly, to a decoy support structure that produces better movement of the decoy. A hunting decoy according to the present invention, for example, can be shaped and colored to represent a wild turkey. However, the invention of this application has much broader applications and should not be limited to hunting decoys.

2. Prior Art

Decoys are known in various shapes and colors to resemble specific animals, a familiar example being game birds. The decoys may be attractive to the corresponding species of game animal or to a different species, as a result of various instincts. These include (for example) social herding or similar safety-in-numbers instincts, predation or other expectation of finding food, opportunities for procreation, the urge to maintain territorial exclusivity, establishment of a place in a hierarchical pecking order, etc.

A decoy advantageously resembles a particular species accurately, at least as to attributes that a target species is inclined to notice. The decoy may be quite realistic, or may simply have critical attributes in common with the particular species it emulates, such as a comparable silhouette, color, movement, sound, odor, etc.

Decoys that appear realistic to humans are more popular among hunters than those that are obviously artificial. The target species may be prone to respond, positively or negatively, to the same aspects as humans, or possibly other aspects. Visually, many animals are highly sensitive to motion.

Visual mimicry is an important consideration, but not the only one. Decoys should be inexpensive to manufacture. The decoy should be compact or subject to packing in a manner that permits a hunter to carry a number of decoys into the field. The decoys should individually be very easy to deploy, quickly and silently, in any terrain that may be encountered, such as open grassland, woods or scrub vegetation.

U.S. Pat. No. 5,570,531 describes a bird decoy with motion associated with the head and neck. The decoy body is stationary. A one-piece head-and-neck portion is mounted to the body so that the head and neck may tilt when sufficient wind prevails. The decoy is helpful in that it moves, but it is not representative of a live animal, whose motion is unlikely to involve displacement of an integrally rigid head and neck relative to a rigid stationary body, even when the animal is standing in place.

U.S. Pat. No. 5,515,637 discloses a decoy in which the decoy body is mounted on a vertical journal axis by bearings. The idea is for ambient breeze to rotate the body on the vertical journal axis without substantial frictional resistance. The journal axis is set precisely vertical. The weight of the decoy is balanced evenly on opposite sides of the axis. The mounting comprises a helical spring which enables the breeze to wobble the decoy in the incident direction of the breeze. However, the pivot point of the device is not optional.

In a frictionless rotational mounting of such a type, it is also possible that the decoy body may turn one way or the other on the vertical axis, due to wind or another impetus. Turning on a vertical axis may appear natural in some conditions and therefore could be interesting to a game animal. However the wind speed and direction must catch the decoy body just right. If the wind is not at the particular speed and oriented in the specific direction that produces a convincing motion, the motion may be such that the decoy is caused to appear as an obvious fake. This problem is acute if there are several decoys deployed in a group. It might appear natural and interesting, for example, for decoys in a group occasionally to face in a new direction, for example as live animals in a group might face in unison toward the source of a sound. If decoys in a group rotate freely, a gust of wind could cause them to rotate in different directions and to continue beyond a full revolution. Such motion is mechanical and unrealistic.

If the rotation axis of a journal mounting is not at the center of mass, and the rotation axis is tilted relative to vertical, the decoy body will rotate preferentially to a stable rotational position at which the heaviest part of the decoy is at the lowest elevation. A gust of wind may act to rotate the body due to differences in surface area, for example exerting greater pressure on the thicker tail section than the thinner head section, causing a rotational force. This may rotationally displace the heaviest part of the decoy body from the angular position at which the heaviest part is at the lowest possible elevation. When the wind force subsides, the body tends to rotate back to the preferred orientation, because the heaviest part of the decoy body settles back at the preferred lowermost elevation. Typically, there is an associated rotational oscillation of a decreasing amplitude around the preferred rotational orientation, as the body settles back to the preferred orientation.

When deploying several decoys, particularly in a situation in which the decoys must be placed quickly and quietly before the hunter is spotted by the game, the hunter cannot take time to test and adjust the verticality of the rotation axes and the balance of the decoy bodies so as to face all the decoys in parallel or nearly parallel directions. Some of the ground stakes are likely to be set more near to vertical than others, which causes certain decoys in a group to be prone to rotate in the wind, while others do not. Even if care has been taken and the decoy bodies are all faced in parallel, balanced and aligned on vertical rotation axes, they may respond to a gust of wind by spinning around 360 degrees or more, possibly in different rotational directions, and may look obviously artificial.

A game animal is sensitive to motion and expects to see realistic motion in live animals. Suspicious unrealistic motion detracts from the effectiveness of the decoy. A group of decoy bodies that spin on their axes in a relatively uncontrolled and mechanical way, facing in random directions at any given time, and possibly spinning though more than 180 or even 360 degrees, is suspicious even if the static shape and color of the decoys is highly realistic.

### SUMMARY OF THE INVENTION

The present invention is applicable generally to visual decoys that are intended to approximate the appearance of a particular species, and preferably to exhibit realistic forms of motion. The decoys may represent any species and/or gender to which animals instinctively respond. A particularly demanding subject as well as a good demonstrative example is the American wild turkey.

Wild turkeys are wary animals with acute senses. Male turkeys are territorial and will challenge another male turkey in an established geographical range. Turkeys of either gender may approach other turkeys to establish dominance in a pecking order. Turkeys are large birds but they can fly a substantial distance and thus can very quickly move about in response to situations.

The invention is, therefore, described with reference to wild turkeys. However, the invention is also applicable to other particular species. For example, the invention can be applied to decoys representing animals that frequent dry land or water, mammals or birds, prey animals or predators, etc. Further, the invention of this application can be used in connection with predator animals to prevent damage from unwanted wildlife or any other use associated with simulating wildlife.

In accordance with the present invention, a decoy is provided which advantageously produces lifelike motion by including multiple points of movement simulating the movement of the particular animal without producing unlimited movement. Moreover, the decoy according to the present invention is easy to deploy and can be made to be compact for transporting several decoys. More particularly, the decoy in accordance with the present invention includes separate spring mounts between the body structure and the head structure to allow the body and the head to move relative to one another and minimize the likelihood of the decoy being out of balance.

In accordance with another aspect of the present invention, provided is a support structure that also allows the decoy to rotate about a vertical axis to create yet another degree of movement.

In accordance with a further aspect of the present invention, provided is a damping mechanism to help restrict the movement of the decoy body and the decoy head. The damping device can be, for example, a rubber or polymer sleeve coaxial to and covering the spring mechanisms. In another embodiment, the damping or homing of the moving parts relative to the other components can be achieved by the shaped relationship between the moving parts such as by detents in one or more of the components of the movement joints.

In accordance with even yet another aspect of the present invention, the degree of rotation of the decoy about the vertical axis can also be limited while allowing the movement described above.

In accordance with yet a further aspect of the present invention, provided is a support structure that can be used with existing decoys or new decoys that provides the described advantageous.

These and other aspects of the invention will be apparent to those skilled in the art in view of the following discussion and the appended claims.

### BRIEF DESCRIPTION OF THE DRAWINGS

The foregoing will in part be obvious and in part be pointed out more fully hereinafter in connection with a written description of preferred embodiments of the present invention illustrated in the accompanying drawings in which:

FIG. 1 is a longitudinal sectional view of a hunting decoy assembly according to the invention;

FIG. 2 is a bottom plan view thereof;

FIG. 3 is a partial perspective view showing the detailed structure of a body mounting shaft and a ground stake to prevent full rotation of the decoy;

FIG. 4 is a schematic plan view, in section, showing the operation of the structure shown in FIG. 3;

FIG. 5 is an axial section view through the mounting of a blade-like rotation limiter;

FIG. 6 is a partial perspective view of an alternative embodiment having a pocket for returning the decoy to a desire position;

FIG. 7 is an enlarged partial sectional view of a mounting arrangement between the stake and the decoy body;

FIG. 8 is an enlarged partial sectional view of a mounting arrangement between the stake and the decoy body without a spring arrangement;

FIG. 9 is a partial longitudinal sectional view of a hunting decoy assembly showing another embodiment of the present invention having a bent stake arrangement;

FIG. 10 is a sectional view taken along line 10-10 in FIG. 9;

FIG. 11 is a partial longitudinal sectional view of a hunting decoy assembly showing yet another embodiment of the present invention having a pivoting head;

FIG. 12 is a sectional view taken along line 12-12 in FIG. 11;

FIG. 13 is a partial longitudinal sectional view of a hunting decoy assembly showing yet a further embodiment of the present invention having a bent neck support arrangement;

FIG. 14 is a partial longitudinal sectional view of a hunting decoy assembly showing yet another embodiment of the present invention having a balanced bobbling head;

FIG. 15 is a partial longitudinal sectional view of a hunting decoy assembly showing yet another embodiment of the present invention having a flat base;

FIG. 16 is an exploded view of yet another embodiment of the invention of this application;

FIG. 17 is a partial longitudinal sectional view of a hunting decoy assembly showing yet even another embodiment of the present invention having an L shaped neck support arrangement;

FIG. 18 is a partial longitudinal sectional view of a hunting decoy assembly showing a further embodiment of the present invention having a neck support which includes use of a strip spring arrangement;

FIG. 19 is a partial longitudinal sectional view of a hunting decoy assembly showing yet a further embodiment of the present invention having neck support which also includes use of a strip spring arrangement;

FIG. 19A is an enlarged view of a spring steel strip shown in FIG. 19; and,

FIG. 20 is a partial longitudinal sectional view of a hunting decoy assembly showing yet a further embodiment of the present invention having an anti-rotation feature.

### DETAILED DESCRIPTION OF THE PREFERRED EMBODIMENTS

The invention of this application relates to animal figurines that can be used as hunting decoys. Lindaman U.S. Pat. Nos. 6,216,382 and 6,481,147 disclose hunting decoys including a hollow decoy structure and a support stake support structure and are hereby incorporated by reference for showing the same. Samaras U.S. Pat. No. 6,092,322 discloses a decoy with moving body parts and is also incorporated by reference herein for showing the same. Johnson U.S. Pat. No. 5,515,637 discloses a decoy in which the decoy body is mounted on a vertical stake and is also incorporated by reference herein for showing the same. Sroka U.S. Pat. No. 5,570,531 describes a bird decoy with motion associated with the decoy's head and neck and is also incorporated by reference herein for showing the same.

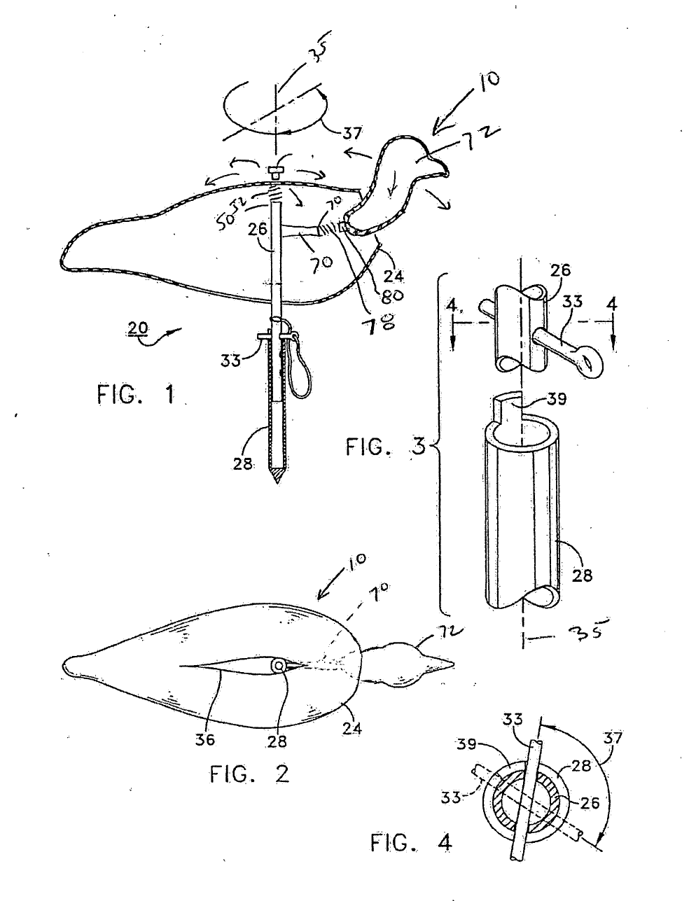

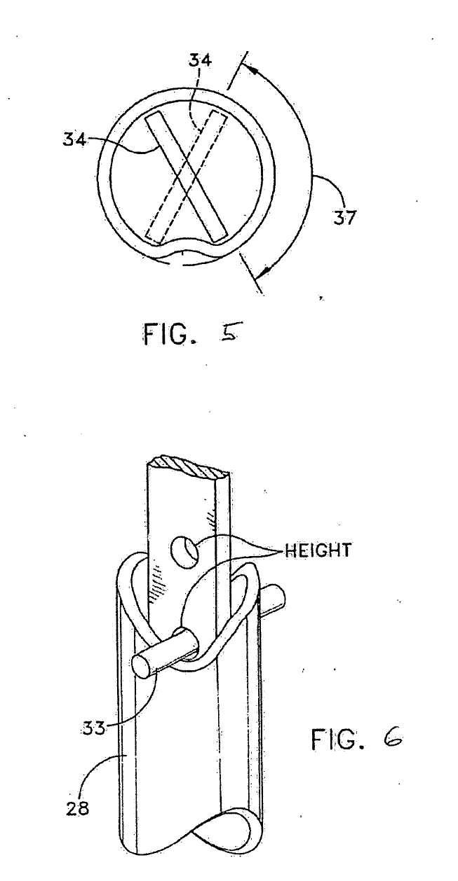

Referring now in greater detail to the drawings wherein the showings are for the purpose of illustrating preferred embodiments of the invention only, and not for the purpose of limiting the invention, FIGS. 1-7 illustrate a hunting decoy 10 assembly according to an aspect of the invention, specifically a turkey decoy, shown in cross section through a medial plane. The assembly generally comprises a hollow decoy body 24 supported on a ground stake 28. A mounting shaft 26 telescopes with the ground stake 28 and extends into engagement with the decoy body. The telescoping connection of the shaft 26 and stake 28 is fixable at discrete height positions by setting a lateral through-pin 33 in one of several spaced lateral holes in shaft 26. When the shaft 26 is inserted into stake 28, shaft 26 telescopes into stake 28 until pin 33 abuts against the top of stake 26. This supports that decoy body vertically, and defines a rotation axis 35. Rotation can be limited by the engagement between pin 33 and stop 39. As a result, the rotation of decoy 10 can be limited to angle 37. As can be appreciated, while one particular water fowl is shown, the invention of the this application can be used with a body structure of any one of a number of different types of water fowl and/or other types of wildlife.

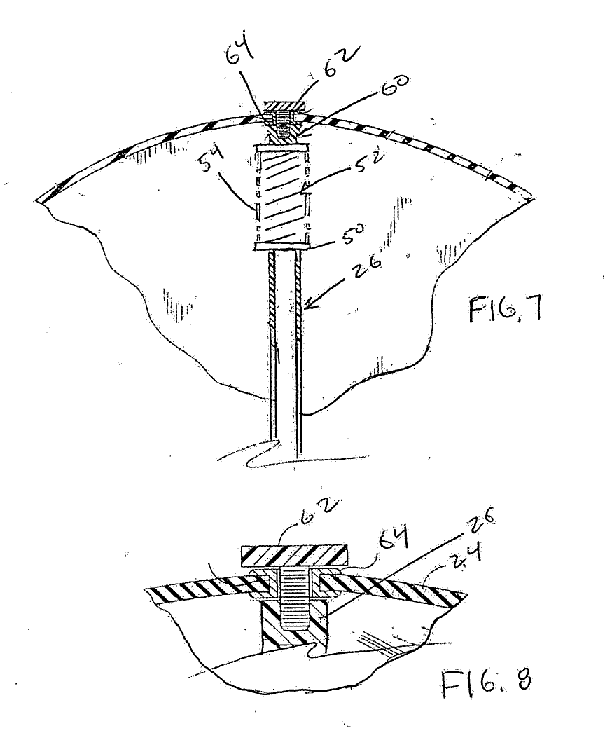

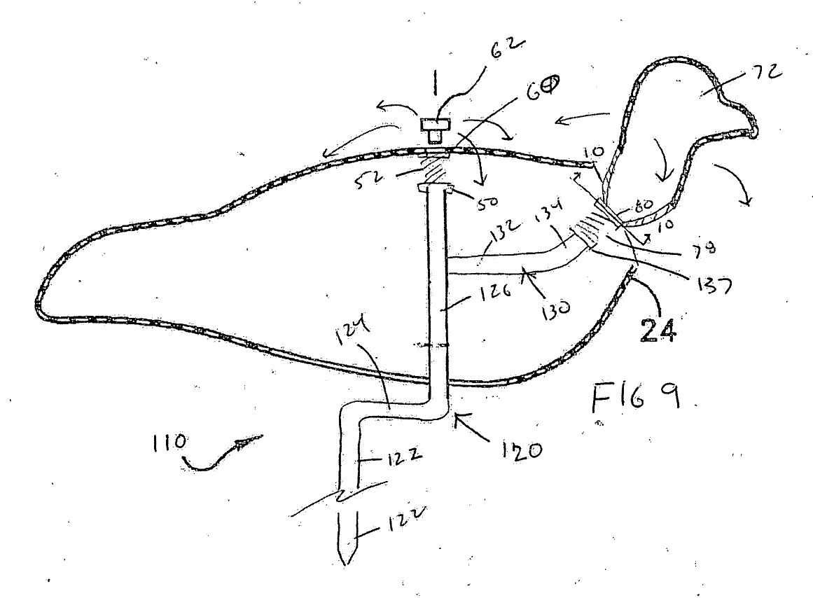

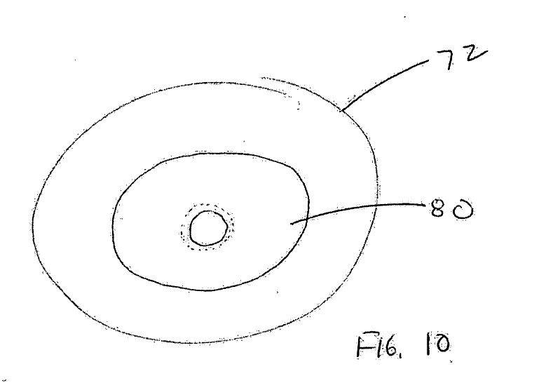

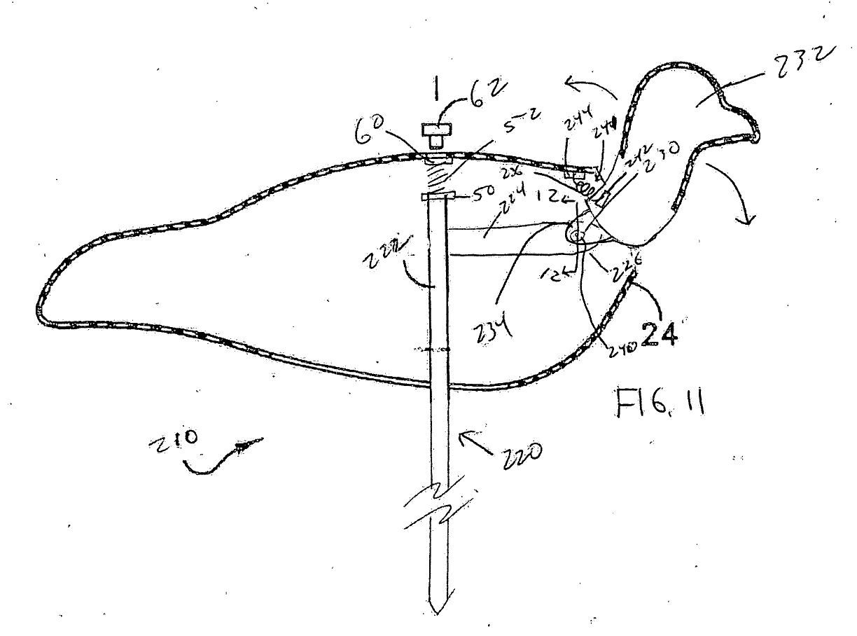

Shaft 26 further includes a top end 50 wherein a spring assembly 52 can be joined thereto. Spring assembly 52 is preferably a coil spring, however, spring 52 can be any biasing member that is capable of producing movement of body 24 relative to shaft 26. Further, spring assembly 52 can include a biasing or damping element 54 to restrict or dampen the movement of the body relative to the shaft. Element 54 can also return the joint to a given position and/or restrict the degree of pivot and/or rotation about the joint. Spring 52 is also joined to mount 60 having a threaded hole to receive a fastener 62. As can be appreciated, while a threaded fastener is shown, other types of fasteners including, but not limited to, adhesives can be used without detracting from the present invention. In addition, a bushing 64 can also be used to prevent premature failure of the decoy. As can be appreciated, it is advantageous to make the decoy body from a lightweight and even a collapsible material for easy transportation. However, these types of material do not always provide the structural integrity needed for a joint between two components. As is shown in FIG. 8, in one embodiment, shaft 26 can be connected directly to body 24.

Shaft 26 further includes a forward shaft section 70 for supporting a decoy head 72. In this respect, shaft section 70 has an end 76 wherein spring assembly 78 is joined thereto. On the opposite end of spring assembly 78 is a mounting element 80. Head 72 is joined to element SO and is allowed to move relative to shall section 70 and/or decoy body 24 based on the articulation of spring assembly 78. As with spring assembly 52, spring assembly 78 is preferably a coil spring, however, spring 78 can also be any biasing member that can produce the desired movement of head 72 relative to shaft section 70. Further, spring assembly 78 can include a biasing or damping element (not shown) to restrict or dampen the movement of the head relative to the shaft and/or body. Head 72 can also be joined to mount SO by a threaded fastener or can be attached utilizing any known fastening method including, but not limited to, adhesives.

In the following discussions concerning additional embodiments of the present invention, common components will be referred to with common reference numbers.

FIGS. 9 and 10 show yet another embodiment of the present invention. As can be appreciated, while not shown, this embodiment, as with the other embodiments of the present invention, can include other variations described above and below. More particularly, these figures show a decoy 110 having a decoy body 24 and a head 72. Decoy 110 includes a stake 120 having a lower, generally vertical section 122, a generally horizontal mid-section 124 and an upper section 126. This stake arrangement allows the decoy to rotate about lower section 122 based on the direction of the wind. Stake 120 further includes a forward shaft section 130 that is curved upwardly for use with wildlife having a more upright head position. More particularly, shaft section 130 has a generally horizontal section 132 and an upwardly extending section 134 wherein section 134 has an end 137. Spring assembly 73 is joined to end 137 in the same fashion as described above.

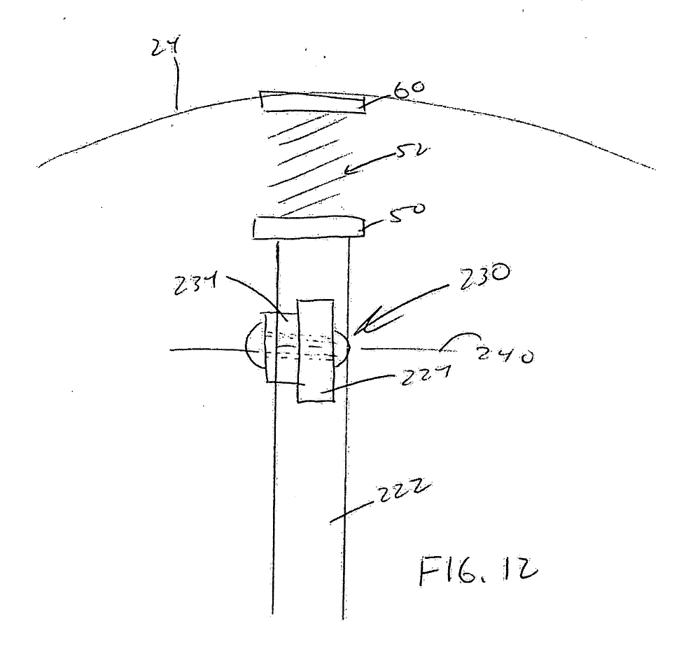

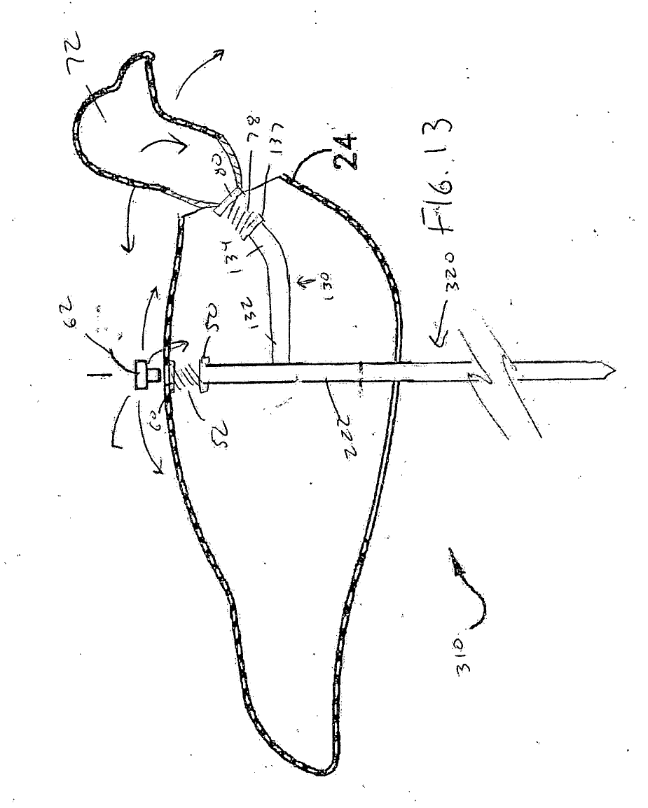

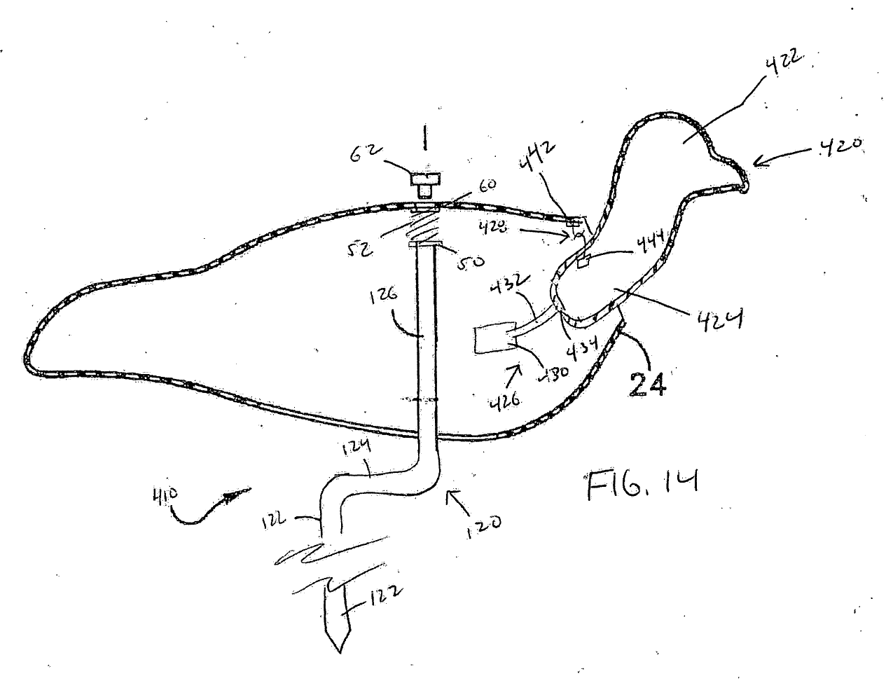

FIGS. 11 and 12 show yet another embodiment of the present invention. In this respect, shown is decoy 2 10 having a stake 220 having a generally vertical section 222 and a forward section 224. Forward section 224 has an end 226 having a first portion of a pivot joint 230. Decoy 2 10 further includes a head 232 having a base 234 which includes a second portion of pivot joint 230. Pivot 230 allows head 232 to move about an axis 240 relative to stake section 224. While, as with other components, wind is utilized to create the body motion of the decoy, head 232 includes a centering device 241 to maintain the head at a natural central position and to ensure that the head returns to this central or home position. This particular embodiment produces a pecking motion. Further, as is shown, head 232 is also influenced by the movement of the body. In this respect, centering device 241 can be joined to body 24 thereby being influenced by the motion of body 24. While not shown, the centering device could also be jointed to stake 220 and/or incorporated into pivot 230. Centering device 241 includes a mount 242 connected to head 232, a mount 244 connected to body 24 and a biasing member 236. As with other embodiments, while member 236 can be a spring, other flexible devices and/or materials can be utilized without detracting from the invention.

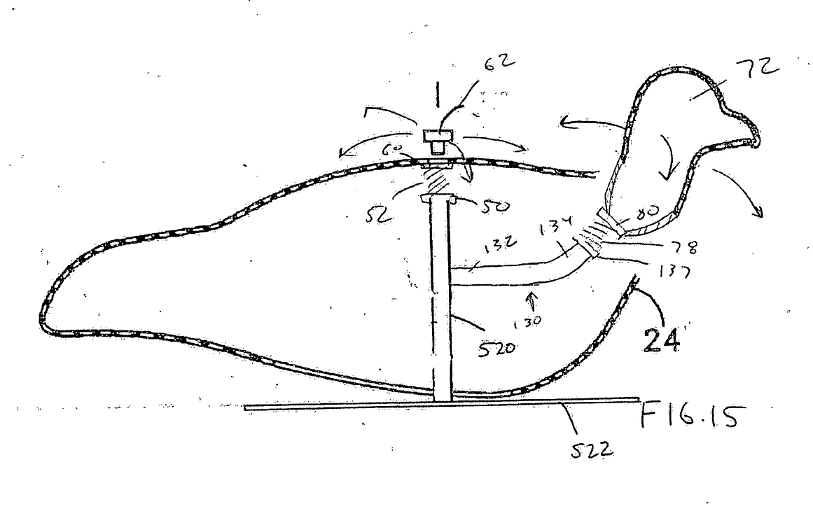

FIG. 13 shows yet another embodiment of the invention of this application. More particularly, shown is a decoy 310 having a straight stake 320 with mounting am 130 and shows yet another combination of features.

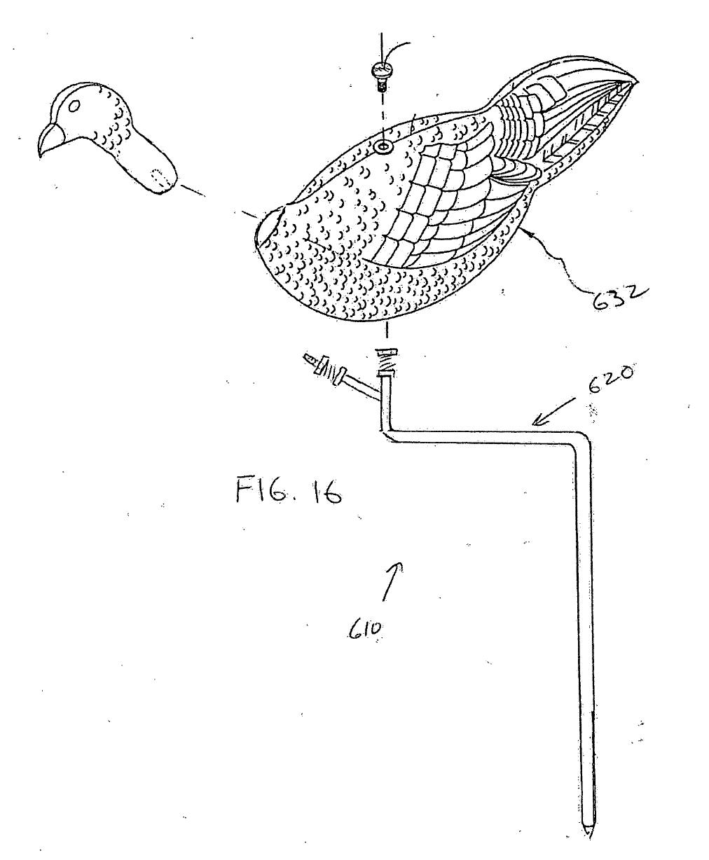

FIG. 14 shows even yet another embodiment of the invention of this application. In this respect, shown is a decoy 410 with stake 120 and a bubblehead 420. While decoy 410 is shown with stake 120, as is stated above with respect to other embodiments, other stake or base configurations can be utilized in this embodiment. With respect to the head mechanism, bubblehead 420 is also influenced by wind, however, bubblehead 420 is separate from stake 120. More particularly, bubblehead 420 includes a head 422, a neck 424, a weight system 426 and a hanging system 428. Hanging system 428 retains bobblehead 420 relative to body 24 and weight system 426 helps control the bobbling action of bobblehead 420. Neck 424 provides a more realistic look for the decoy. Weight system 426 includes a weight 430 that can be directly attached to head 422 and/or neck 424 or can be spaced from head 422 and/or neck 424 by a weight am 432. As can be appreciated, based on the weight of head 424 and the desired position of hanging system 428 and head 424, it may be necessary to space the weight from the head to achieve a desired neutral head position (the position the head will return to when external forces are remove). Ann 432 it attached to neck end 434. As can be appreciated, neck 424 could also be extended to act as weight 430 and/or arm 432. With respect, to hanging system 428, included is a body hanger 442 and a head hanger 444. Body hanger 442 is attached to body 24 and head hanger is connected bobblehead 420 at a balance position wherein bobblehead 420 is held in a desired position relative to body 24. While hangers 442 and 444 are shown to be hooks, any know hanging mechanism could be used which produces the desired head movement including, but not limited to a hook and a loop, two loops and even a flexible strap. In addition, hanging system 428 could also be supported by a forwardly extending section of the support structure or stake (not shown).

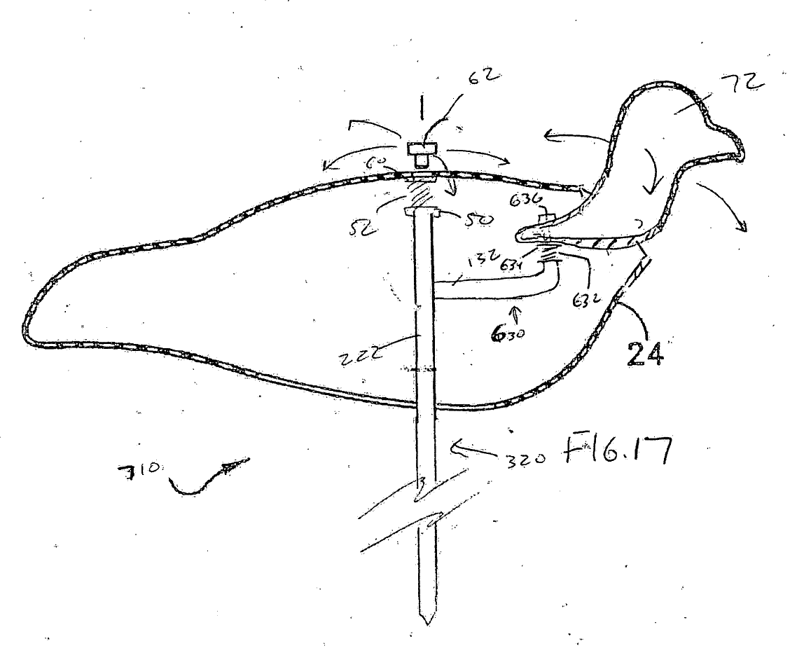

FIG. 15 shows yet a further embodiment of the invention of this application. More particularly, shown is a decoy 510 having a support 520 with a flat base 522. By utilizing base 522, a decoy can be deployed, with all the features described above, on surfaces wherein a stake is not effective. While only one flat base configuration is shown, the base can be any known base designed to maintain a decoy on a desired underlying surface.

FIG. 16 shows even yet another embodiment of the invention of this application. More particularly, shown is a decoy 610 having a straight stake 620 with an angled support arm 630. Further, shown is a decoy that can be easily disassembled for compact storage and easy transportation. In this respect, decoy 610 can include a collapsible decoy body 632 such that body 632 and head 72 can be easily removed from stake 620 and be stored compactly for transportation and/or storage. Again, as is emphasized above, these features can be utilized in other embodiments such that any of the above described decoys can utilize collapsible decoy body 632.

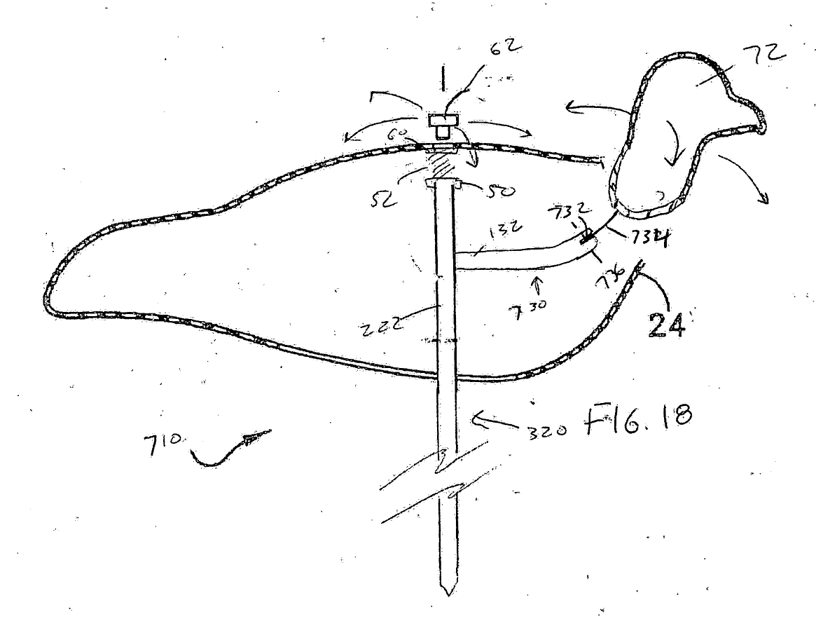

FIG. 17 shows yet a further embodiment of the invention of this application. More particularly, shown is a decoy 410 having an L shaped mounting arm 630 with a spring 632 on the end of am 630 with a spring mount 634. A fastener 636 can be used to secure head 72 to the spring mount.

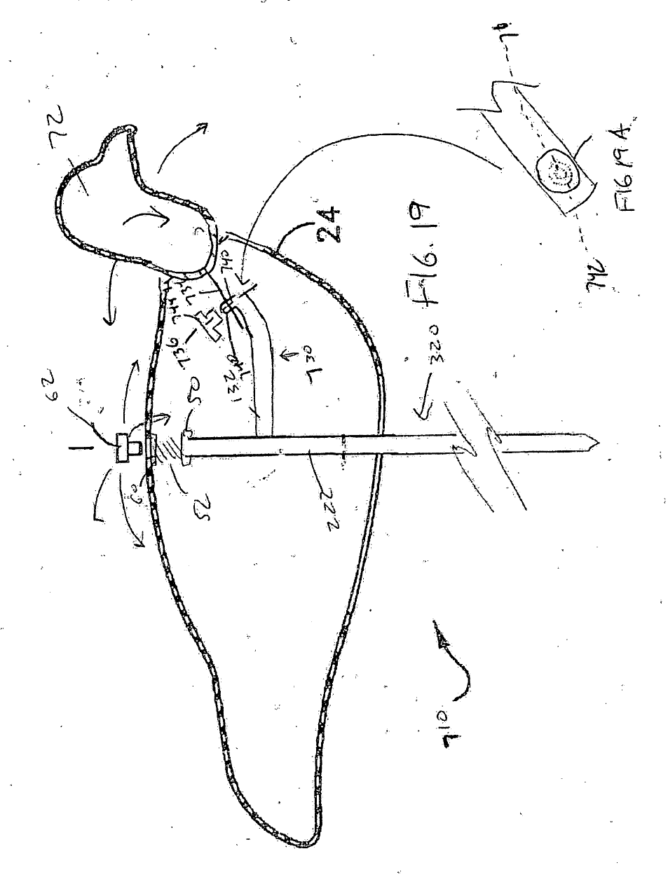

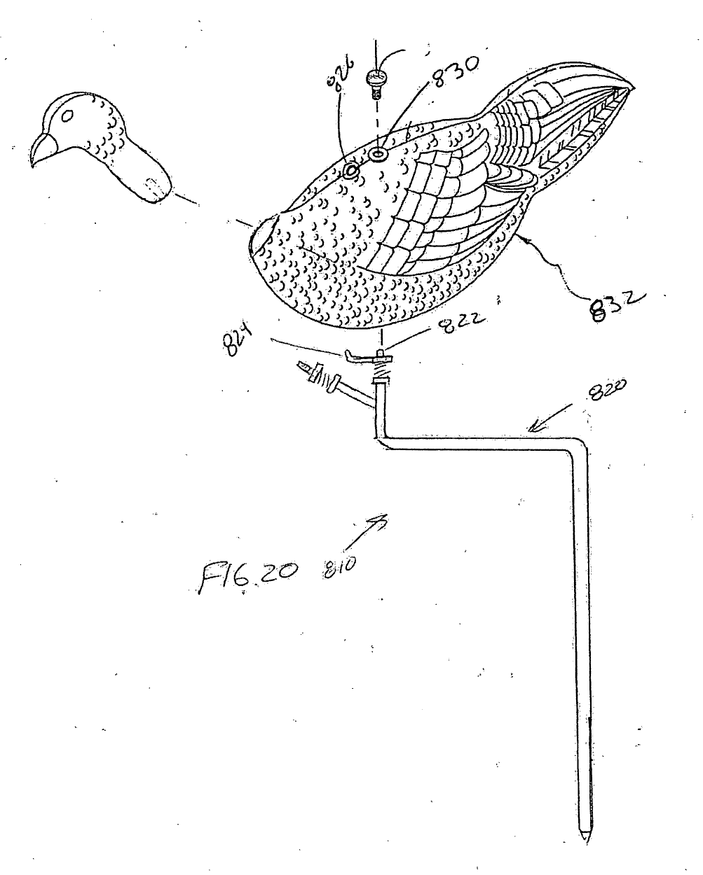

FIG. 18 shows even yet a further embodiment of the invention of this application. More particularly, shown is a decoy 710 having a mounting arm 730 with a slot 732. Slot 732 is shaped to receive a spring steel strip 734 that produces, at least in part, the motion of head 72 relative to the body. In this respect, the inter-engagement between strip 734 and slot 732 allows limited rotation of spring strip 734 about an axis 736. FIG. 19 shows another attaching method for spring steel strip 734. More particularly, arm 730 can include a nipple 740 and strip can include a mounting hole 742 for attaching strip 734 to the stake. A fastener 744 can be used to secure the strip to the nipple. As with the embodiment shown in FIG. 18, head and spring strip 734 can rotate about axis 736 while the spring steel produces wobbling motions. As can be appreciated, other joining methods can be used for connecting the spring steel.

FIG. 20 shows even yet another embodiment of the invention of this application. More particularly, shown is a decoy 810 having a stake 820 which includes an anti- rotation feature. In this respect, stake mount 822 can be configured to pass through hole 830 in decoy 832 similarly to the decoys and stakes described above. However, in addition, mount 822 can include an anti-rotation feature such as an anti-rotation am 824 extending from mount 822. Arm 824 is L shaped and extends through a second hole 826 in decoy body 832 when the decoy body is in the mounted condition. As can be appreciated, this configuration can be used to prevent the decoy body from rotating relative to the stake. Further, stake mount 822 can also include an elongated portion and hole 830 can have a corresponding elongated configuration such that the decoy body is prevented from rotating relative to the stake. If limited rotation is desired, hole 826 could be an arcuate slot thereby allowing arm 824 to move along the slot, however, this movement would be limited by the length of the slot. As is stated above and as with other embodiments, the anti-rotation feature of stake 820 can be used in connection with other embodiments of this application.

In accordance with the foregoing description, the inventive decoy assembly includes a support for carrying the decoy assembly relative to a ground surface, a decoy body mounted on the support such that the decoy body is movable relative to the support, and a decoy head portion mounted on the support, the decoy head portion being movable relative to the support independently of movement of the body relative to the support. The support defines at least one rotation axis and at least one of the decoy body and the decoy head is affixed to the support so as to permit rotation on said axis and also pivoting on another axis, wherein the axis for said rotation is different from the axis for said pivoting. The body is mounted on the support such that the rotation axis permits limited rotation of the body on a vertical axis. The limited rotation of the body on the vertical axis is controlled by at least one of a resilient engagement and an angularly limited freedom. The body can be affixed on an end of a stake member by a damped engagement with a spring fitting. The spring fitting can comprise a flexible length whereby the axis for pivoting of the body on the support is defined by flexing of the spring fitting.

In certain embodiments, the support has first and second shaft portions mounted relative to one another at an angle, wherein the shaft portions are fixed and stationary and wherein one of the shaft portions movably supports the decoy body and the other of the shaft portions movably supports the decoy head assembly. The shaft portion that movably supports the decoy body can be substantially vertical. The shaft portion that movably supports the decoy head assembly can diverge from vertical to determine an orientation of a decoy head. At least one and optionally both of the shaft portions that movably supports one of the decoy body and the decoy head assembly, respectively, can include an attachment fitting that permits rotation of said at least one of the respective body and head assembly relative to its said shaft portion and also permits transverse pivoting of said at least one of the respective body and head assembly relative to its said shaft portion. The attachment fitting advantageously has a spring clamp that engages the respective body and head assembly. In one example, the attachment fitting has a helical compression spring that engages respective body and head assembly, wherein compression of said spring damps rotation and wherein flexing of the spring defines a transverse pivoting movement.

The decoy assembly in the nonlimiting examples resembles a fowl such as a turkey or goose. The transverse pivoting movement of the respective at least one of the body and head assembly in that case is configured to simulate at least one of a faxing movement of the fowl, a bobbing movement and a pecking movement.

While considerable emphasis has been placed on the preferred embodiment of the invention illustrated and described herein, it will be appreciated that other embodiments can be made and that many changes can be made in the preferred embodiment without departing from the principles of the invention. Accordingly, it is to be distinctly understood that the foregoing descriptive matter is to be interpreted merely as illustrative of the invention and not as a limitation.

What is claimed is:

1. A decoy assembly, comprising:
a support for carrying the decoy assembly relative to a ground surface;
a decoy body mounted on the support such that the decoy body is movable relative to the support;
a decoy head portion mounted on the support, the decoy head portion being movable relative to the support independently of movement of the body relative to the support.

2. The decoy assembly of claim 1, wherein the support defines at least one rotation axis and at least one of the decoy body and the decoy head is affixed to the support so as to permit rotation on said axis and also pivoting on another axis, wherein the axis for said rotation is different from the axis for said pivoting.

3. The decoy assembly of claim 2, wherein the body is mounted on the support such that the rotation axis permits limited rotation of the body on a vertical axis.

4. The decoy assembly of claim 3, wherein the limited rotation of the body on the vertical axis is controlled by at least one of a resilient engagement and an angularly limited freedom.

5. The decoy assembly of claim 3, wherein the body is affixed on an end of a stake member by a damped engagement with a spring fitting.

6. The decoy assembly of claim 5, wherein the spring fitting comprises a flexible length whereby the axis for pivoting of the body on the support is defined by flexing of the spring fitting.

7. The decoy assembly of claim 2, wherein the support comprising first and second shaft portions mounted relative to one another at an angle, wherein the shaft portions are fixed and stationary and wherein one of the shaft portions movably supports the decoy body and the other of the shaft portions movably supports the decoy head assembly.

8. The decoy assembly of claim 7, wherein the shaft portion movably supporting the decoy body is substantially vertical and the shaft portion movably supporting the decoy head assembly diverges from vertical to determine an orientation of a decoy head.

9. The decoy assembly of claim 8, wherein at least one of said shaft portions movably supporting the decoy body and the decoy head assembly, respectively, comprising an attachment fitting that permits rotation of said at least one of the respective body and head assembly relative to its said shaft portion and also permits transverse pivoting of said at least one of the respective body and head assembly relative to its said shaft portion.

10. The decoy assembly of claim 9, wherein at least one said attachment fitting comprising a spring clamp that engages said respective body and head assembly.

11. The decoy assembly of claim 9, wherein at least one said attachment fitting comprises a helical compression spring that engages respective body and head assembly, wherein compression of said spring damps rotation and wherein flexing of the spring defines a transverse pivoting movement.

12. The decoy assembly of claim 11, wherein the decoy assembly is arranged to resemble a fowl and the transverse pivoting movement of the respective at least one of the body and head assembly is configured to simulate at least one of a faxing movement of the fowl, a bobbing movement and a pecking movement.

13. A decoy assembly comprising:
a support member for holding the decoy assembly on a ground surface, the support member having a main support shaft disposed substantially upright and a diverging support shaft affixed relative to the main support shaft at an angle;
a hollow decoy body having a back coupled by a fitting to the main support shaft and a front having an opening providing clearance with the support shaft, wherein the fitting is disposed adjacent to a top end of the main support shaft and permits the decoy body to rotate and to rock relative to the main support shaft;
a decoy head coupled by a fitting the diverging support shaft, wherein the decoy head is movable relative to the support shaft independently of the decoy body.

14. The decoy assembly of claim 13, wherein the fitting coupling the decoy body to the main support shaft is rotatable on a substantially vertical axis and comprises a spring portion permitting flexing transverse to said vertical axis, whereby the body can rotate relative to the main support shaft and rock relative to the ground surface.

15. The decoy assembly of claim 14, wherein at least one of the fitting and the support shaft is structured for one of angularly limiting and damping rotation of the body on the main support shaft.

16. The decoy assembly of claim 13, wherein the fitting coupling the decoy head to the diverging support shaft comprises a spring portion that flexes to permit the decoy head to bob.
